(19) United States
(12) Patent Application Publication
(10) Pub. No.: US 2007/0150401 A1
(43) Pub. Date: Jun. 28, 2007

(54) Graphical user interface and method for displaying market data and entering trading orders

(76) Inventors: Steven J. Brucato, Naperville, IL (US); Belal K. Faruki, North Aurora, IL (US)

Correspondence Address: MICHAEL P. MAZZA, LLC, 686 CRESCENT BLVD., GLEN ELYN, IL, 60137, US

(21) Appl. No.: 11/318,296

(22) Filed: Dec. 23, 2005

(51) Int. Cl. G06Q 40/00

(52) U.S. Cl. 705/37

(57) ABSTRACT

A method, and a graphical user interface and communicating user input device, for use in electronic trading an instrument on an electronic exchange having an inside market. Aligned dyamic bid, dynamic offer and dynamic price ladders are displayed, either in conventional grid format or in “price wheels” or other spatial configurations, which may include regions of expanded and compressed data to enhance both trader viewing and spatial and trading efficiency. Using the present invention, order parameters for a potential trade order may be displayed using an initial single user action; during display, the dynamic price ladder may continue to move, and may be displayed, without affecting the display of selected order parameters. Different order parameters may also be selected and, when desired, via a final single user action, a trade with the desired order parameters may be executed (i.e., sent to the electronic exchange). Other advantages of the present invention will be understood from the description and claims.

### BACKGROUND OF THE INVENTION

The disclosures of U.S. Pat. Nos. 6,938,011 and 6,772,132 are hereby incorporated by reference into this application in their entirety.

The present invention generally relates to computerized trading systems. More specifically, the invention relates to a novel method for displaying market data and facilitating the entry of trading orders using specialized graphical user interfaces (GUIs).

As trading of stocks, bonds, and derivatives (futures and options) increasingly move away from manual “pit” markets and toward electronic markets and electronic trading, the display of bids and offers in a market feed and the ability to track the movement of these bids and offers through an infinite range of prices, permitting rapid order-entry decisions, becomes ever more important to a trader's success. Further, the ability to quickly enter an order having the intended price and quantity is, likewise, critical to a trader's success.

An electronic market allows participants to view market data by electronic means, enter orders into the market electronically, and receive trade reports electronically (e.g., via computer). Typically, an electronic market consists of a market host computer(s), a computer communication network, and various trading systems connected to the host via the communications network. The host computer manages inbound orders, matches buyers with sellers via a variety of matching algorithms, and notifies traders of trades they have been involved in. Trading systems used by traders and trading firms range in type from manually-based “click” trading systems in which users enter trades via a GUI, to automated or “black box” trading systems where the system automatically enters orders based on various market conditions. These orders may travel through the communications network to the market host.

GUI and corresponding software components of past and current computerized trading systems have visually presented market data in a spatially limited manner, typically employing grid control components in which individual entries are automatically assigned the same grid box size. Examples of such prior visual presentations are shown in FIGS. 3-5 of U.S. Pat. No. 6,772,132. Especially in volatile markets, such spatial limitations can hamstring a trader's order-entry decisions, as the range of prices that bids and offers span can quickly scroll off the screen, out of sight of the visible window of prices that a trader can see in a conventional market display.

Accordingly, it would be advantageous to provide a computerized trading system with associated GUI and software, providing the ability to visually track the range of bid and offer prices through an infinite range of prices, while still retaining a spatial sense of where the market has moved from and to. It would also be advantageous to allow the display of more data in a smaller space, as the range of prices that can be displayed in a constrained area can be much greater than in conventional, equally-sized spaces.

### SUMMARY OF THE INVENTION

The present invention provides a novel presentation of market data in a visual manner that gives a trader the ability to watch the bids and offers in a market feed and track the movement of these bids through an infinite range of prices. One embodiment of the invention permits the display of more data in a smaller space on the computer screen, without hampering, and in fact enhancing, the display of the most useful and/or commonly-used data. Using this embodiment, the range of prices that can be displayed in a constrained area is greater than in currently offered systems. In this preferred embodiment, the size of price labels becomes smaller as those price labels are positioned farther from the center of the display. Since traders often view and submit orders nearest the best bid and offer in the market, displaying these areas with a maximum size is beneficial as this allows the trader to more easily view prices and enter orders in these areas. As prices are displayed farther away from the best bid and offer, it is useful to conserve space by shrinking the size of these price and volume values. This spatial ordering of the visual display presented to the trader offers the trader two distinct advantages. First, the trader can view a larger useful range of prices and track the market movement across a longer useful range of prices. Second, this conserves space on the computer display. Since traders often desire to see large amounts of data, it can be important to show as much useful data in as compressed a space as possible. Other embodiments of the invention are believed useful and are discussed below.

Accordingly, in a preferred embodiment of the present invention a graphical user interface is provided, using appropriate software, in communication with a computer and a user input device, such as a mouse, for use in electronically trading an instrument on an electronic exchange having an inside market. Using a computer monitor or screen, for example, a visual display may be provided of market depth of the traded instrument using dynamic bid ladders and dynamic offer ladders, which may include a plurality of bids and a plurality of offers in the market for the traded instrument, respectively, including at least a portion of the bid and offer quantities of the traded instrument. The dynamic bid and offer ladders are preferably aligned with a dynamic price ladder displaying prices corresponding to the bids and the offers. An order entry region is provided which is at least partially coextensive with the dynamic bid and dynamic offer ladders. The order entry region includes a plurality of areas for receiving commands from the user input device to send trade orders. A particular area in the order entry region may be selected through an initial single user action of the user input device with a pointer of the user input device positioned over the particular area to display a particular order region showing order parameters for the trade order. The particular order region may again be selected through a final single user action of the user input device to send the trade order to the electronic exchange.

In a particularly preferred embodiment, the user input device is a mouse, the initial single user action includes a first click on a portion of the mouse by the user, and the final single user action includes a second click on a portion of the mouse by the user. The order entry region may include bid entries such as a dynamic bid ladder, and offer entries such as a dynamic offer ladder. Following the initial single user action, the displayed order parameters may correspond to a bid or offer which existed as of the time of the initial single user action. Also, following the initial single user action, a different area in the order entry region may be selected through subsequent initial single user action, thereby displaying the same or different order parameters depending upon movement in the market for the traded instrument. Different corresponding bid and/or offer prices may be displayed from those selected per the displayed order parameters, given intervening trading occurring for the traded instrument following the initial single user action. These different corresponding bid and/or offer prices may be differentiated for the user in a visually perceptible manner from other bid and/or offer prices in the dynamic bid and offer ladders, such as by being partially highlighted in colors corresponding to whether the price is a bid or an offer.

In alternative embodiments, the price entries may be static or dynamic, and bid, offer and price entries may be arranged in various configurations, such as a partial wheel (such as if row compression is enabled) or in column form (such as if row compression is disabled and a conventional grid format is used). Alternatively, these entries may be spatially configured in a horizontal fashion. The order parameters may include quantity and/or time of day. Default order quantities may be set or changed by single user action of the user input device, after first positioning the pointer on a selected bid or offer in the dynamic bid or dynamic offer ladders.

Portions of data displayed in the dynamic price wheel may be visually compressed, such as by using row compression techniques as described below. If row compression is used, preferably a portion of one or more of the bid, offer and price entries located in areas substantially remote from the center of the visual display is compressed relative to a portion of the entries located in areas substantially adjacent the center of the visual display.

In a preferred embodiment, the price entries are at least partially dynamic in nature and are caused to scroll when the outside market reaches an edge of the visual display and/or when the inside market reaches an edge of the visual display. Alternatively, or in addition, the bid and offer volumes may be caused to wrap adjacent an end of the price entries when the outside market reaches an edge of the visual display. In another, locked, mode, no scrolling of the price entries or wrapping of the bid or offer volumes may be enabled. In another, dynamic, mode, the inside market may be caused to remain substantially fixed near the center of the visual display, with the price entries permitted to scroll as needed to retain the inside market in this position.

In an alternative embodiment, a method is provided for placing an electronic trade order for a traded instrument on an electronic exchange having an inside market, using a graphical user interface communicating with a computer and a user input device. Market depth is displayed for the traded instrument using bid ladders and offer ladders which may be dynamic and which include a plurality of bids and a plurality of offers in the market for the traded instrument, respectively. These include at least a portion of the bid and offer quantities of the traded instrument. Preferably, dynamic bid and offer ladders are aligned with a dynamic price ladder displaying prices corresponding to the bids and the offers. An order entry region is provided which is at least partially coextensive with the dynamic bid and dynamic offer ladders. The order entry region includes a plurality of areas for receiving commands from the user input device to send trade orders. A particular area in the order entry region may be selected through an initial single user action of the user input device with a pointer of the user input device positioned over the particular area to display a particular order region showing order parameters for the trade order. The particular order region may again be selected through a final single user action of the user input device to send the trade order to the electronic exchange. Alternatively, following the initial selection of the particular area in the order entry region through the initial single user action, a different area in the order entry region may be selected through subsequent initial single user action, thereby displaying the same or different order parameters depending upon movement in the market for the traded instrument.

In yet another embodiment, a graphical user interface is provided for communicating with a computer and a user input device for use in electronically trading an instrument on an electronic exchange having an inside market. This interface includes a visual display of market depth of the traded instrument including bid and offer entries of a plurality of bids and a plurality of offers in the market for the traded instrument. The bid and offer ladders include at least a portion of the bid and offer quantities of the traded instrument and are aligned with price entries displaying prices corresponding to the bids and the offers. A portion of the bid, offer and price entries located in areas substantially remote from the center of the visual display may be compressed relative to other portions of those entries located substantially adjacent the center of the visual display. The bid and offer entries may be dynamic, and may be aligned with a dynamic price ladder. Alternatively, the bid and offer ladders may be aligned with a static price ladder. An order entry region at least partially coextensive with the bid and offer ladders may be provided, with the order entry region including a plurality of areas for receiving commands from the user input device to send trade orders. Once again, a particular area in the order entry region may be selected through an initial single user action of the user input device with a pointer of the user input device positioned over the particular area to display a particular order region showing order parameters for the trade order. The particular order region may again be selected through a final single user action of the user input device to send the trade order to the electronic exchange.

In another alternative embodiment, a graphical user interface is provided which communicates with a computer and a user input device for use in electronically trading an instrument on an electronic exchange having an inside market. The interface includes a visual display of market depth of the traded instrument showing aligned bid, offer and dynamic price entries. One or more bid, offer or price entries are automatically differentiated for the user in a visually perceptible manner from other such entries, facilitating the user's ability to track market movement for the traded instrument. This differentiation may take the form of color-coded highlighting or bordering of one or more bid, offer or price entries, such that the color-coding enables the user to more easily differentiate between bid, offer and price entries. In an alternative embodiment, when a range of available bid or offer volumes reaches an edge of the visual display, the price entries may be caused to convers from a static to a dynamic, moving (e.g., scrolling) display. These embodiments may or may not utilize row compression, depending upon the trader's preference.

### BRIEF DESCRIPTION OF THE DRAWINGS

The novel features which are characteristic of the invention are set forth in the appended claims. The invention itself, however, together with further objects and attendant advantages thereof, can be better understood by reference to the following description taken in connection with the accompanying drawings, in which:

FIGS. 1 and 2 are successive visual displays, known as a Rotator™ display, for an electronic trading application according to a preferred embodiment of the present invention, showing the basic user interface that displays market data (prices and volumes for a traded instrument) through a range of prices as the bid and offer volumes change prices, in which data located remote from the center of the screen may be shrunk in size through a row compression technique;

FIGS. 3A and 3B are schematic illustrations of the parameters (radius and linear range length) that control row compression;

FIG. 4 shows successive visual displays of a row compression embodiment of the invention operating in “Scroll Mode”;

FIG. 5 shows successive visual displays of a row compression embodiment of the invention operating in “Wrap Mode”;

FIG. 6 shows a visual display of an embodiment of a row compression embodiment of the invention operating in “Locked Mode”;

FIG. 6a shows a visual display of a row compression embodiment of the invention operating in “Dynamic Mode”;

FIG. 7 shows successive visual displays using a conventional grid (i.e., without row compression);

FIG. 8 shows successive visual displays using a conventional grid, in Scroll Mode, with Scroll occurring when the best offer hits the extent of the visible display or window;

FIG. 9 shows successive visual displays using a conventional grid, in Scroll Mode, with Scroll occurring when the worst offer hits the extent of the visible display;

FIG. 9a is a visual display of the invention using a conventional grid, in Wrap Mode;

FIG. 9b is successive visual displays of the invention using a conventional grid, in Dynamic Mode;

FIG. 10 is successive visual displays demonstrating a preferred embodiment of the invention in which the trader may enter a sell order by first hovering a pointer over the best offer and then clicking on it; and

FIG. 11 is successive visual displays showing that if the trader moves the pointer to a different row, a new price may be selected.

The components in the drawings are not necessarily to scale, emphasis instead being placed upon clearly illustrating the principles of the present invention. In the drawings, like reference numerals designate corresponding parts throughout the several views.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Dynamic price ladder” means a display of prices for a traded instrument, often consisting of price levels or rows, moving on the visual display in response to market changes. “Dynamic bid ladder” means a plurality of bids, each corresponding to specific prices and quantities for the traded instrument, moving in an aligned fashion with the dynamic price ladder. “Dynamic offer ladder” means a plurality of offers/asks, each corresponding to specific prices and quantities for the traded instrument, moving in an aligned fashion with the dynamic price ladder.

“Inside market” means the highest bid price (“best bid offer”) and the lowest offer (or ask) price for a traded instrument.

“Market depth” means the full range of current bid and current offer (or ask) prices and corresponding quantities or volumes in the market for a traded instrument.

“Order entry region” means the region on the visual display in which user input and interaction with the visual display, using an appropriate input device, occurs enabling the performance of trading-related operations.

“Single user action” means any action by a user within a short period of time, whether consisting of one or more clicks of a mouse button or other input devices, as a means for user input and interaction with the visual display.

“Static price ladder” means a display of prices on the visual display, often consisting of price levels or rows, that do not normally change position on the visual display in response to new market information, absent receipt of a recentering command.

“Traded instrument” means any article of commerce which may be traded, including but not limited to stocks, bonds, commodities and derivatives (futures and options).

“Visual display” means any display(s) of trading-related data providing information to facilitate electronic trading, which may include but is not limited to displays on a computer monitor or terminal.

“Volume” refers to a traded instrument's aggregate quantities of bids or offers/asks.

### DETAILED DESCRIPTION OF THE PREFERRED EMBODIMENTS

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

Rotator™ With Row Compression

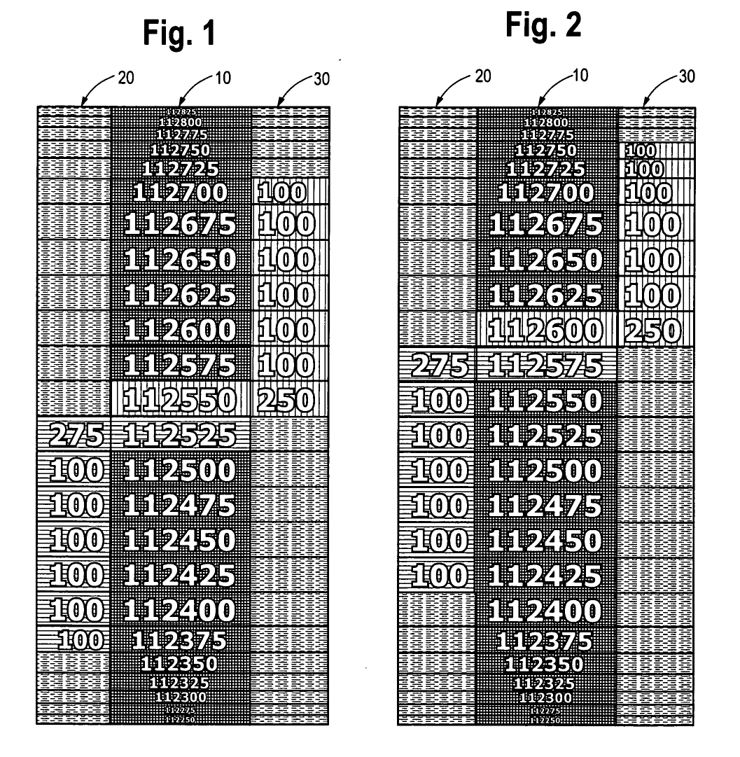

Referring first to FIGS. 1-2 and 4-5a, a basic user-interface is shown that displays market data (prices and volumes) through a range of prices as the best bid and offer rise in price. This market data is preferably dynamic in the sense that it is updated in real time to reflect current market events; With regard to FIGS. 1-2 and 4-5, the GUI display has the following major components: arranged price entries 10, which may take the form of a partial price “wheel” 10 (lined for color, such as grey), bid volume wheel 20 (e.g., blue), and offer volume wheel 30 (e.g., red), when row compression is involved, as explained below, or which may take the form of price columns when displayed in conventional grid format, as also explained below. As shown, arranged price entries 10 may be located in the center wheel (alternatively, they may be located on the left or right of the screen or interface); entries 10 consist of a range of prices at which bids and offers may be displayed. Price wheel 10 may rotate upwardly or downwardly (or at an angle or horizontally) as described below. Bid volume wheel 20 is the left wheel (which may also be interchanged with either the price or offer volume wheels), and shows the range of bid volumes currently available in the market, preferably adjacent to the price level at which the volumes are available. This wheel is preferably locked to the price wheel, meaning the bid volume associated with a particular price is preferably shown next to that price. Offer volume wheel 30 is the right wheel (which may also be interchanged with either the price or offer volume wheels), and shows the range of offer volumes currently available in the market, preferably adjacent to the price level at which the volumes are available. This wheel is also preferably locked to the price wheel, meaning the offer volume associated with a particular price is preferably shown next to that price. Bid volumes wheel 20 and offer volumes wheel 30 may rotate upwardly, for example, as price wheel 10 rotates downwardly (or, conversely, each wheel could be designed to spin in opposite directions). Again, it will be understood that price wheel 10 may, alternatively, be located on the left or right side, with the other wheels correspondingly located in alternative locations.

Referring now to FIG. 2, it can be seen that the market has moved up, i.e., bid and offer prices are now higher (such that wheels 20 and 30 have each rotated upwardly two grid boxes in distance). In this embodiment, because the range of bid and offer volumes still fit on the visual display/window, the price wheel has not yet rotated.

Rotator™/Row Compression with Scrolling, Wrap, Dynamic and Locked Modes

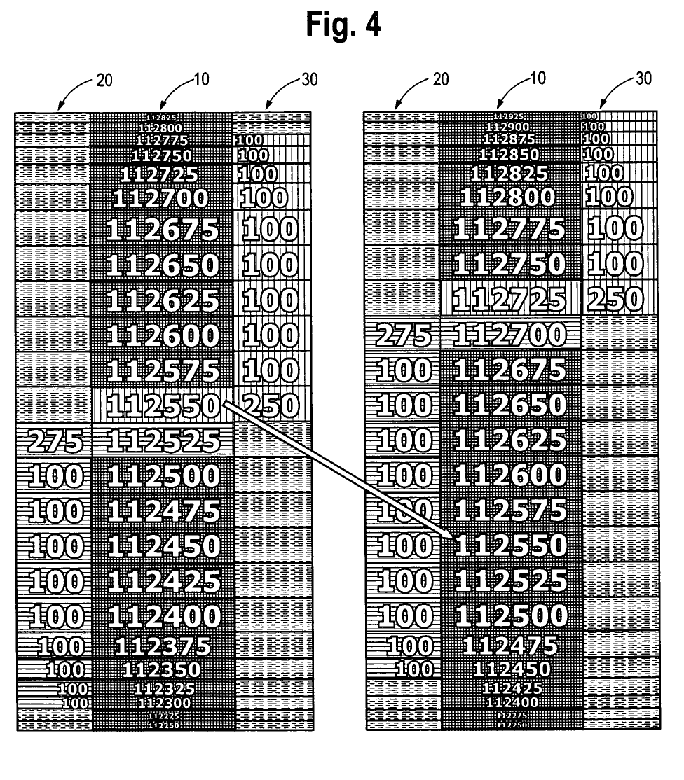

The Rotator™ visual display of the present invention may include several modes that affect how the display behaves when bid or offer volumes reach the extent of the visible range of price values. Referring to FIG. 4, in Scroll Mode, the values in price column 10 may move upwardly or downwardly once the range of available bid or offer volumes has reached the upper or lower extent of the visual display or window. In other words, price column scrolling may be caused to commence whenever: (a) the outside market (worst bid or worst offer) reaches the extent of the display; or (b) the inside market reaches the extent of the display. In other words, in Scroll Mode price wheel 10 may rotate downwardly as bid and offer price wheels 20 and 30 move upwardly, but only when the range of offer volumes has reached the top extent of the display. Still referring to FIG. 4, it can be seen that the former best offer price (“112550” as shown by the arrow) is now displayed in a lower row position because the price wheel has rotated downward.

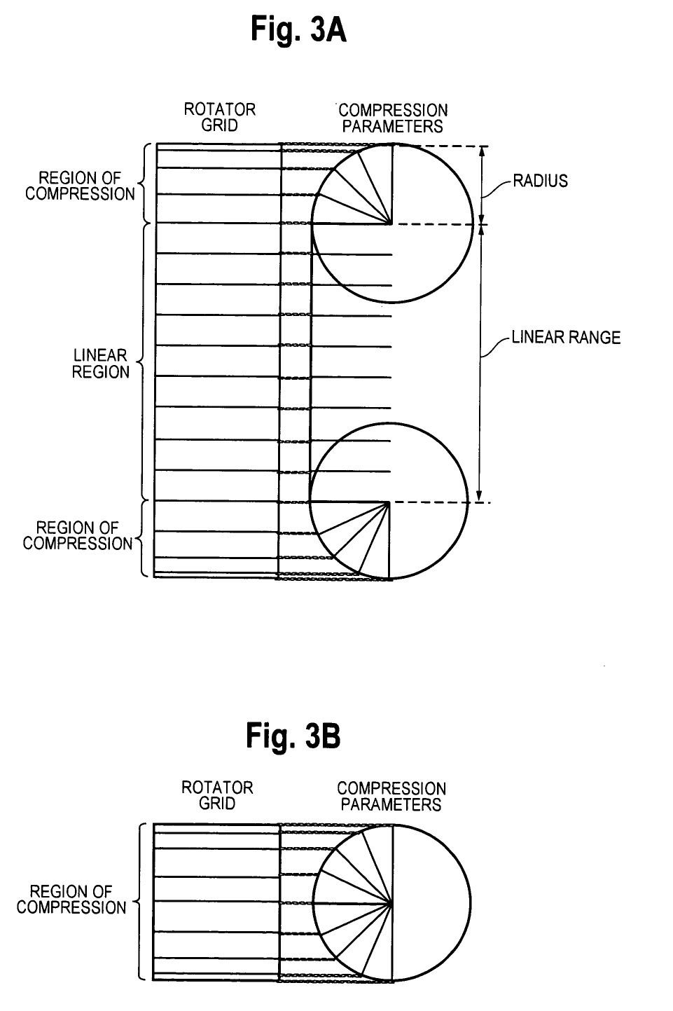

It will now be understood that when Rotator™ acts in Scroll Mode, price ladder 10 operates dynamically when the range of available bid or offer volumes reaches the edge of the visual display. Accordingly, in Scroll Mode the price column constitutes a dynamic display, as a function of both market movement and sizing parameters (as shown in FIGS. 3A and 3B).

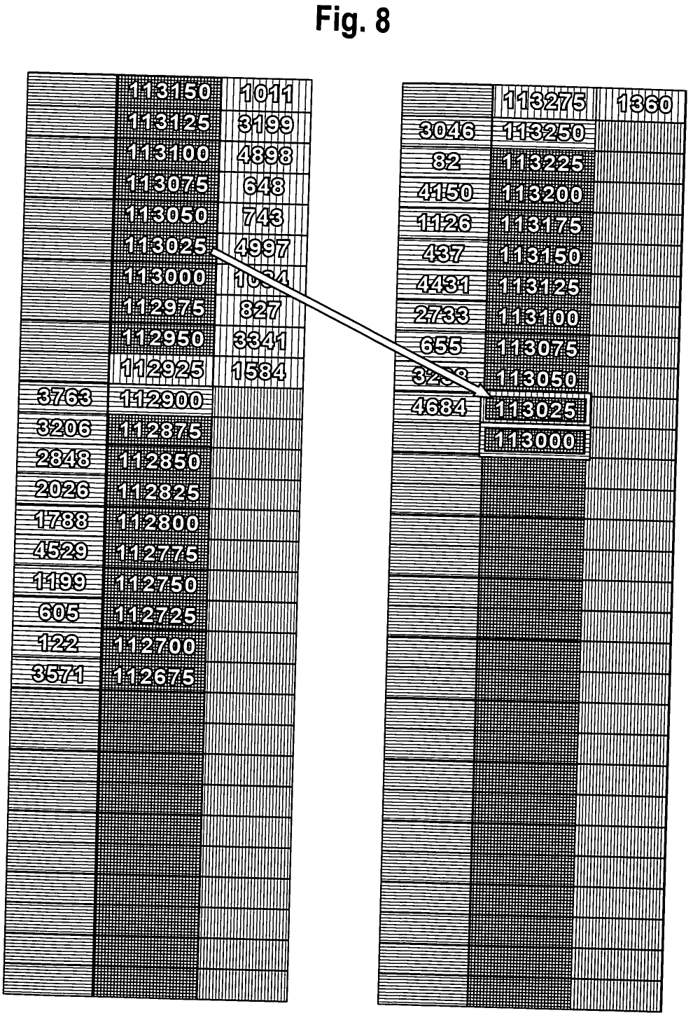

In a particularly preferred embodiment, the previous best bid and offer, before scrolling commences, may be highlighted with a border (e.g., “113025” may be provided with a red border, while “113000” may be provided with a blue border, as shown in FIG. 8). This provides the trader with a spatial perspective of how far the market has moved.

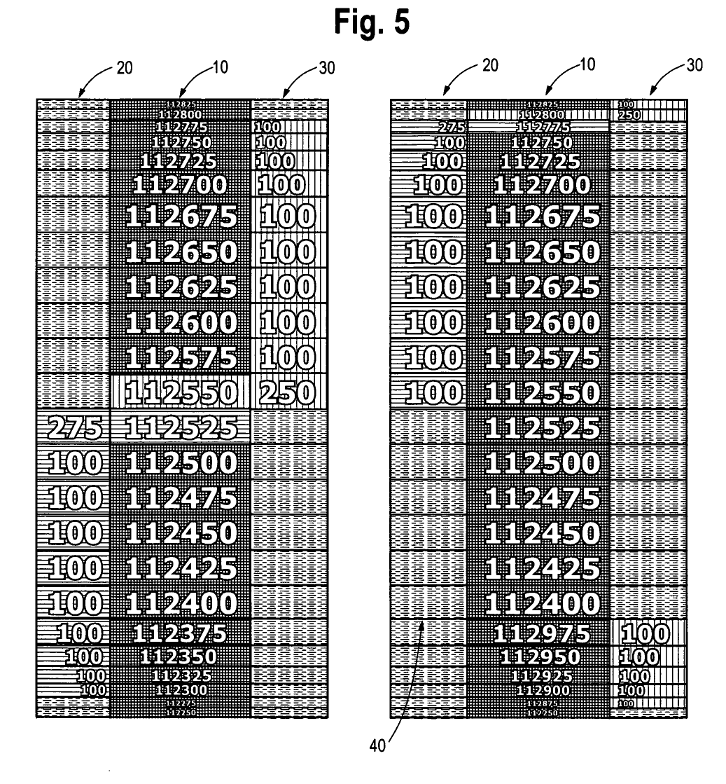

Referring now to FIG. 5, a Wrap Mode may be commenced once the outside market reaches the extent of the display, allowing bid and offer volumes to wrap to the other end of the display (the bottom of the price wheel) as bid and offer prices move upwardly beyond the range of prices visible in the display. It may be seen in this embodiment that the top price of the “wrapped portion” of the bottom of the wheel 10 in FIG. 5 is “112975,” which is a higher price than the price label immediately above it (above line 40), which is “112400.”

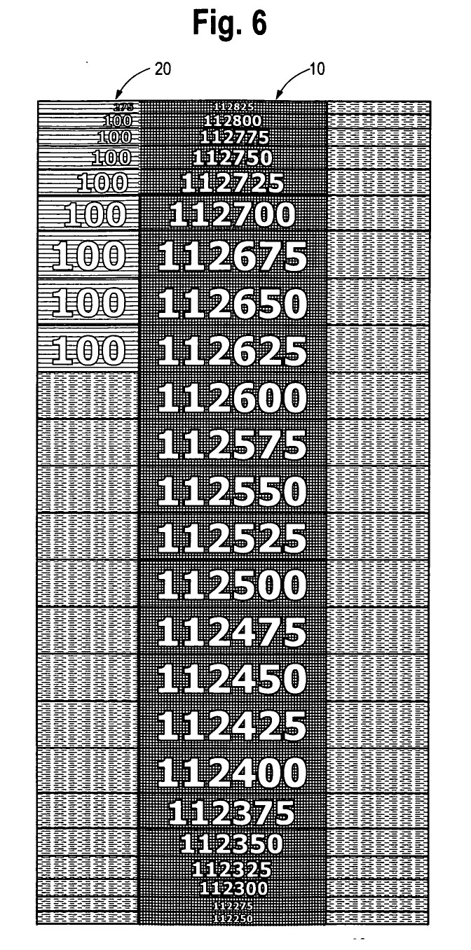

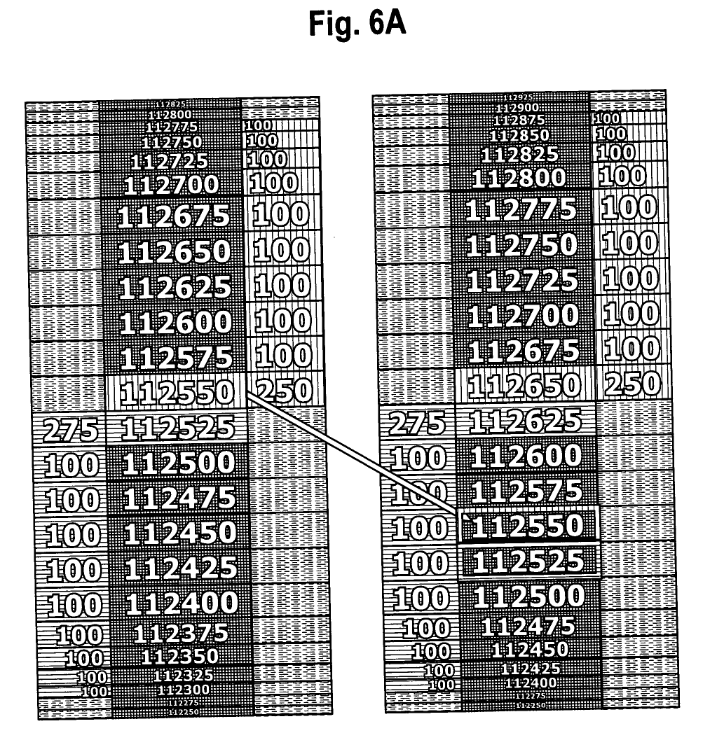

Referring now to FIG. 6, a Locked Mode may be provided in which none of the columns scroll or wrap. In this mode, it is possible for the inside and outside market (full market depth) to move partially or completely outside the visible bounds of the display. In the preferred embodiment, in Locked Mode the price entries constitute a static price ladder in which the market is permitted to scroll right off the window.

Referring now to FIG. 6a, a Dynamic Mode may be provided in which the inside market (best bid and best offer) remain fixed at the center (or nearest to the center) rows. In this mode, the price column may scroll as needed to keep the best bid and best offer at the center-most two rows of the visual display.

In all modes, the trading application may be designed to allow the trader to center the best bid and best offer to the vertical center of the visible display by employing a single user action (such as a single mouse click). If the display is in Scroll Mode, any highlighting or bordering on the previous bid and offer values may be automatically removed upon receipt of a re-centering command.

In a particularly preferred embodiment of the Rotator™ trading application of the present invention, a Row Compression feature may be supported. This features enables the reduction of row height near the upper and lower edges of the display, for example, permitting the display of a greater range of prices in a smaller amount of screen space. The extent of row compression may be set by the operator (e.g., the trader or his IT specialist). As shown in FIGS. 3A and 3B, two parameters determine the extent of row compression, it will now be understood that desired expansion (preferably in areas adjacent the center of the visual display window, as shown) and compression (preferably in areas remote from the center of the visual display window, as shown) of trading-related information (“entries”) may be accomplished.

Rotator™ with Conventional Grid (i.e., with Row Compression Disabled)

FIGS. 1-2 and 4-6a, discussed above, show the Rotator™ trading application with Row Compression in which the row heights near the upper and lower edges of the window or other display are successively reduced. This feature may be disabled by the operator and the Rotator™ displayed using a conventional grid.

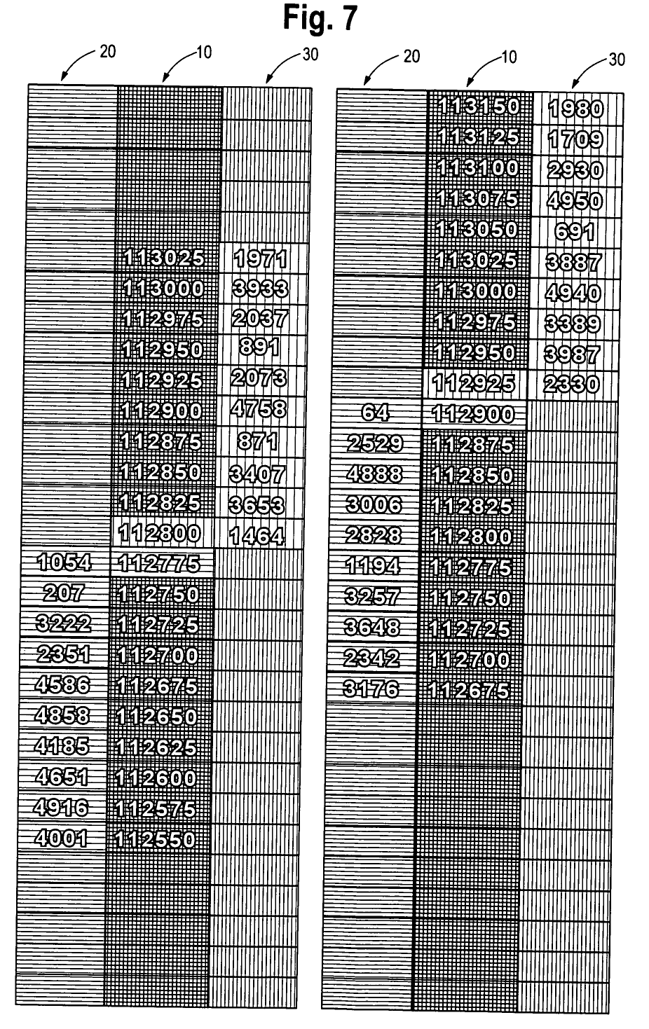

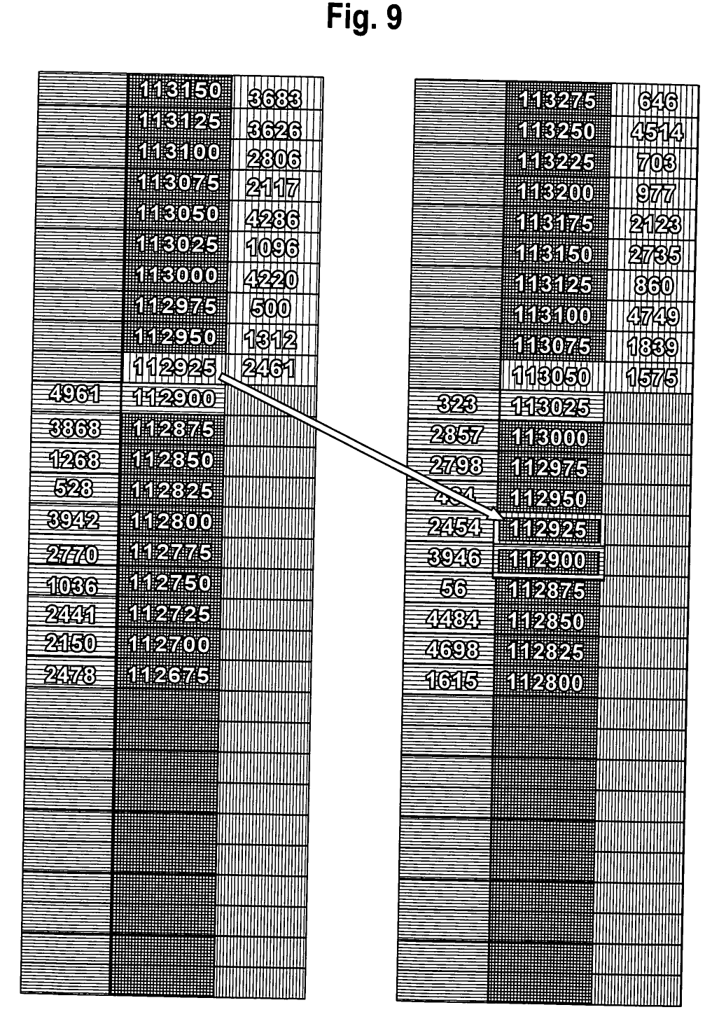

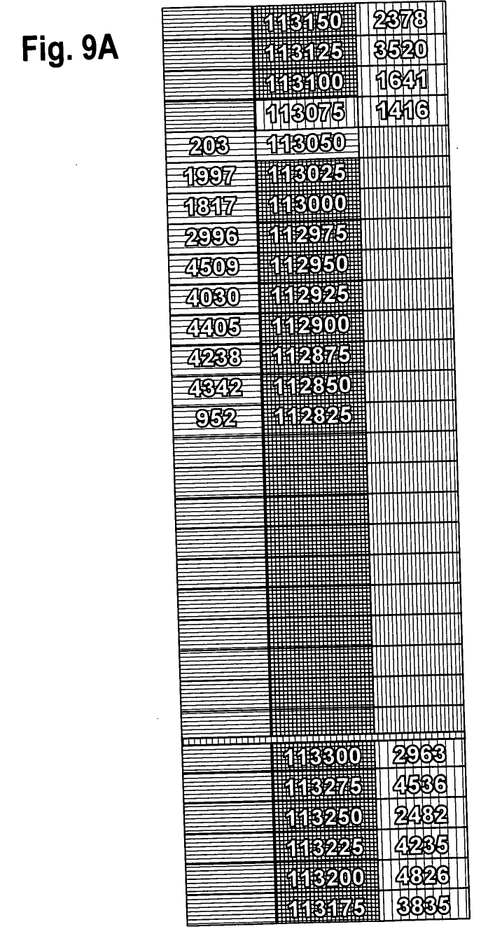

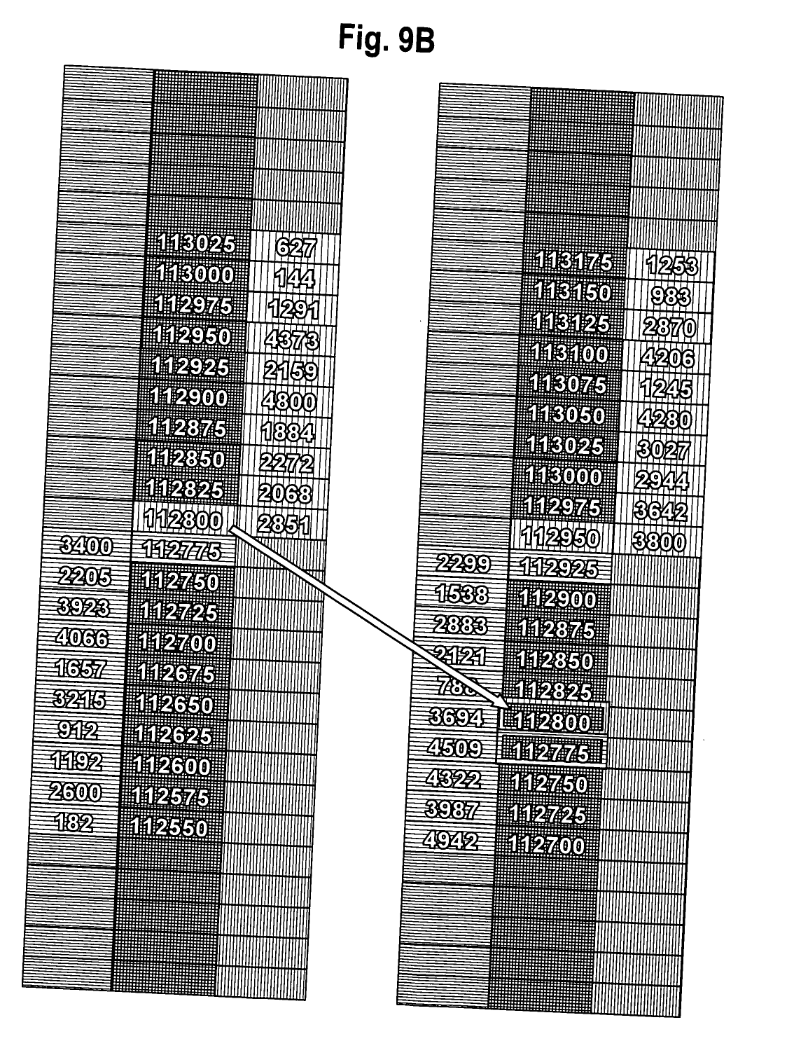

FIGS. 7-11 show the Rotator™ rendered without row compression. In these embodiments, price entries may be arranged in columns and may again be caused to move downwardly as the best bid and offer move upwardly in price. (Of course, opposite movement may be programmed, if desired.) FIG. 8 illustrates a conventional grid example in Scroll Mode, with scrolling occurring when the best offer hits the extent of the visual display. FIG. 9 illustrates a conventional grid example in Scroll Mode, with scrolling occurring when the worst offer hits the extent of the visual display. FIG. 9a shows a similar embodiment in Wrap Mode, while FIG. 9b shows a similar embodiment in Dynamic Mode, in which the best bid and offer are always provided at the center rows of the display. As seen in FIG. 9b, the former best prices may also be provided with highlighted, correspondingly-colored borders (e.g., the “112775” offer in blue, and the “112800” bid in red) to, again, give the trader a spatial perspective of how far the market has moved.

Order Entry

The submission of orders using the present invention may be accomplished in various ways, preferably such as those now described. The trader may be permitted to predefine a default order quantity and order type. Then, via a single user action, such as a mouse click, on any price row in the bid or offer volume wheels 20 or 30, a bid may be entered at the selected price for the previously entered default quantity and type. When “clicking” on bid volume wheel 20, the trader is entering a bid (offer to buy) order. When clicking on offer volume wheel 30, the trader is entering an offer (offer to sell).

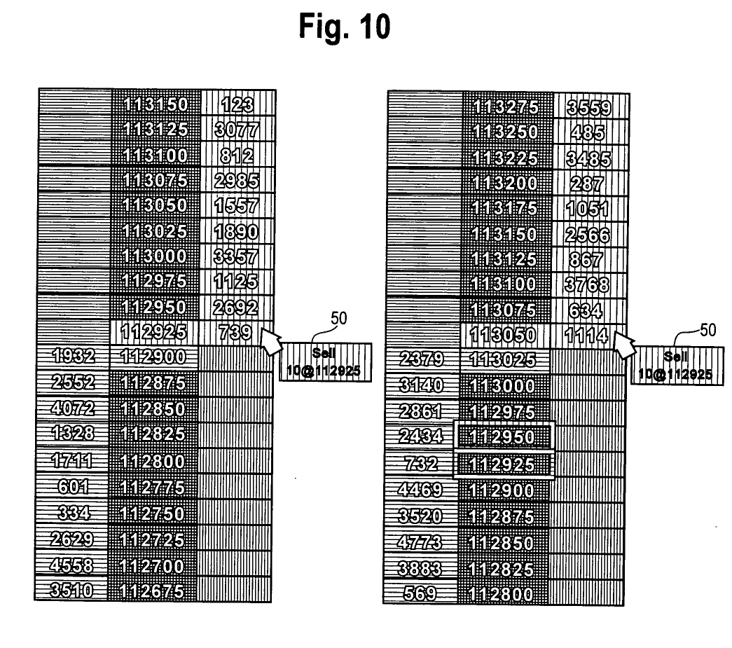

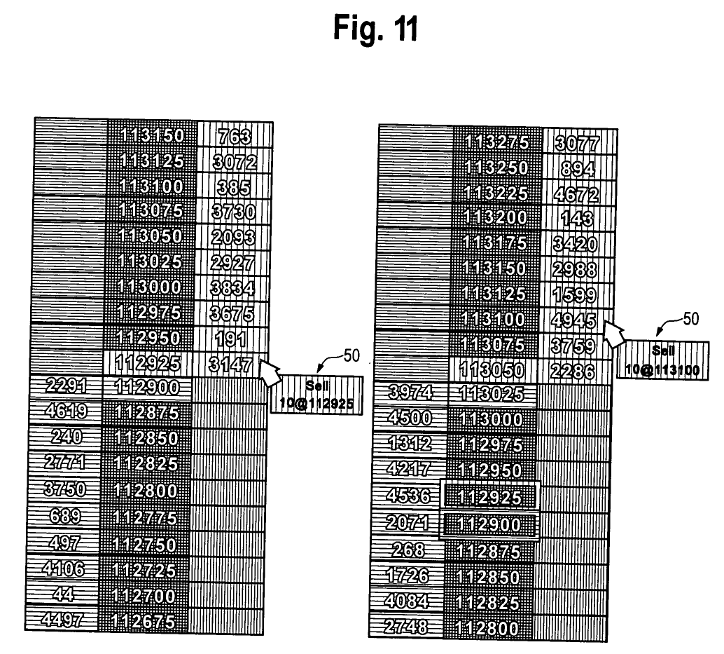

Because traders typically wish to enter orders at a specific price, it is important to allow the trader to select the specific price. Because price wheel or price column 10 can scroll, in a preferred embodiment of the invention the process of selecting a price for order entry is may be accomplished as follows. As soon as the trader hovers the input device pointer over a particular bid or offer volume, the price associated with that volume may be immediately selected and displayed as the desired order entry price. A display, such as pop-up window 50 in FIGS. 10-11, that stays attached to the (e.g.) mouse pointer, may be employed to display the selected order parameters. This pop-up window may be caused to move with the mouse pointer as long as the pointer remains within the bid or offer volume wheel. For as long as this pop-up window is displayed, the trader may click the mouse and enter the order. Preferably, as long as the trader does not move the mouse pointer to a different row or out of the offer volume wheel area, the price for the order remains the same, even if the price wheel rotates. (This removes confusion as to what order has been selected should the market cause the selected entry to move during the selection process.)

FIG. 10 represents this sequence of events. As shown, the trader has hovered the input device (e.g., mouse) pointer over the best offer in order to enter a sell order. At that instant, FIG. 10 (left display) shows that the best offer price was 112925 and the default order quantity entered by the trader was 10. The price is selected and a pop-up window displays the order parameters. FIG. 10 (right display) shows that the market has moved upward (the best bid and offer have moved higher in price), but because the trader has not moved the pointer to a different row location, the originally selected price of the order remains the same. It should be understood that this “price select on pointer hover” feature may be turned off. In a preferred embodiment, this feature may be automatically activated in Scroll and Dynamic Modes, but may also be turned on in Locked Mode, as well.

Continuing with an explanation of this preferred embodiment, and referring now to FIG. 11, if the trader moves the pointer to another row in the bid or offer volume wheel, a new price is selected (“113100” in FIG. 11, right-hand display). In this embodiment if the trader moves the pointer outside of the bid or offer wheel, the pop-up order parameter window may be caused to disappear, such that an order cannot be entered with a single click unless the pointer is moved once again into the bid or offer volume wheels.

It will be understood, of course, that any of the examples illustrating a conventional grid display may be used with Row Compression and vice versa, while still providing similar capabilities and functionality (although Row Compression will, of course, provide enhanced display capabilities given compression of the data).

It should be understood that the GUI display can be rendered at any angle—vertically (as shown), horizontal, or any angle in between. Further, the display may also be configured and utilized without the perspective of a wheel (i.e. without the row compression that gives the effect of a wheel viewed end-on). The ability to track market price movements across an infinite range of prices can also occur if the display is rendered in a strictly linear matter. A standard grid format may be easier to render on some computer systems and while it does not offer the advantage of displaying more prices in a compressed space, it still does provide the advantage of allowing the display of an infinite range of prices.

To provide row compression, commercially available grid control software may be used, such as Microsoft Xceed software, “Xceed Grid,” or Component One software, “Component One Grid.” Using such software, row height may be dynamically adjusted away from the center of the visual display window. This may be implemented by using row height attribute, which may be set on a per-row basis. In doing so, an appropriate software program with appropriate grid control may be written. Font size attribute may also be adjusted on a per-row basis. As those of ordinary skill in the art will appreciate, instead of utilizing commercially available grid control software, a software designer could also build an appropriate grid.

It will be understood that within the scope of the present invention, various input devices may be used to provide interaction between the trader and the computer/visual display, including a clickable mouse, joysticks, arrowing keyboards, touch pads, trackballs, gaming-type controls (up/down, left/right arrows), or other convenient user interfaces.

It should also be appreciated that in addition to providing trading data on the visual display in the spatial configuration of partial “wheels,” as shown in the drawings, other spatial configurations may be provided, if desired, such as horizontal partial wheels, or serpentine, helical or other configurations. In addition, z-axis depth may be provided (e.g., a vertical volume histogram, etc.).

In summary, it will now be apparent to those of ordinary skill in the art that the present invention may provide the electronic trader with any or all of these several significant advantages. These include: the ability to track market price movements across an infinite range of prices; the ability to view a larger range of market prices within the same or a compressed space; the ability to conserve computer display area; and the ability to select and hold a specific order-entry price, avoiding the error of selecting a non-desired price during times when the market price moves quickly.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

We claim:

1. A graphical user interface communicating with a computer and a user input device for use in electronically trading an instrument on an electronic exchange having an inside market, comprising:
a visual display of market depth of the traded instrument using bid entries and offer entries comprising a plurality of bids and a plurality of offers in the market for the traded instrument, respectively, including at least a portion of the bid and offer quantities of the traded instrument, the bid and offer entries being aligned with dynamic price entries displaying prices corresponding to the bids and the offers;
an order entry region at least partially coextensive with the bid and offer entries, the order entry region comprising a plurality of areas for receiving commands from the user input device to send trade orders;
wherein a particular area in the order entry region may be selected through an initial single user action of the user input device with a pointer of the user input device positioned over the particular area to display a particular order region showing order parameters for the trade order, and whereby the particular order region may again be selected through a final single user action of the user input device to send the trade order to the electronic exchange.

2. The graphical user interface of claim 1, wherein the user input device comprises a mouse, and the initial single user action comprises a first click on a portion of the mouse by the user.

3. The graphical user interface of claim 2, wherein the final single user action comprises a second click on a portion of the mouse by the user.

4. The graphical user interface of claim 1, wherein the order entry region comprises bid entries.

5. The graphical user interface of claim 4, wherein the bid entries comprise dynamic bid entries.

6. The graphical user interface of claim 1, wherein the order entry region comprises offer entries.

7. The graphical user interface of claim 6, wherein the offer entries comprise dynamic offer entries.

8. The graphical user interface of claim 1, wherein following the initial single user action, the displayed order parameters correspond to a bid or offer which existed as of the time of the initial single user action.

9. The graphical user interface of claim 1, wherein following the initial single user action, a different area in the order entry region is selected through subsequent initial single user action, thereby displaying the same or different order parameters depending upon movement in the market for the traded instrument.

10. The graphical user interface of claim 8, wherein different corresponding bid and/or offer prices are displayed from those selected per the displayed order parameters, given intervening trading occurring for the traded instrument following the initial single user action.

11. The graphical user interface of claim 10, wherein the different corresponding bid and/or offer entries are differentiated for the user in a visually perceptible manner from other bid and/or offer entries.

12. The graphical user interface of claim 11, wherein the corresponding bid and/or offer prices are at least partially highlighted in colors corresponding to whether the price is a bid or an offer.

13. The graphical user interface of claim 1, wherein the bid, offer and dynamic price entries are configured in the shape of a partial wheel using row compression.

14. The graphical user interface of claim 13, wherein the bid, offer and dynamic price entries are spatially configured in a horizontal fashion.

15. The graphical user interface of claim 1, wherein the order parameters comprise one or more of the following: quantity; and time of day.

16. The graphical user interface of claim 1, wherein default order quantities may be set or changed by single user action of the user input device, after first positioning the pointer on a selected bid or offer.

17. The graphical user interface of claim 14, wherein portions of data displayed in the dynamic price entries are visually compressed.

18. The graphical user interface of claim 1, wherein a portion of one or more of the bid, offer and price entries located in areas substantially remote from the center of the visual display is compressed relative to a portion of the entries located in areas substantially adjacent from the center of the visual display.

19. The graphical user interface of claim 1, wherein row compression is a feature which may be selectively enabled or disabled by a trader.

20. The graphical user interface of claim 18, wherein the compression is accomplished using row compression.

21. The graphical user interface of claim 1, wherein the graphical user interface may be placed in a mode in which the dynamic price entries are caused to scroll when the outside market reaches an edge of the visual display.

22. The graphical user interface of claim 21, wherein the graphical user interface may be placed in a mode in which the dynamic price entries are caused to scroll when the inside market reaches an edge of the visual display.

23. The graphical user interface of claim 1, wherein the graphical user interface may be placed in a mode in which bid and offer entries wrap adjacent an end of the dynamic price entries when the outside market reaches an edge of the visual display.

24. The graphical user interface of claim 1, wherein the graphical user interface may be placed in a mode in which no scrolling of the price entries or wrapping of the bid or offer entries is enabled.

25. The graphical user interface of claim 1, in which the inside market remains aligned with about the center rows of the dynamic price ladder.

26. A method of placing an electronic trade order for a traded instrument on an electronic exchange having an inside market, using a graphical user interface communicating with a computer and a user input device, comprising the steps of:
displaying market depth of the traded instrument using dynamic bid entries and dynamic offer entries comprising a plurality of bids and a plurality of offers in the market for the traded instrument, respectively, including at least a portion of the bid and offer quantities of the traded instrument, the dynamic bid and offer entries being aligned with dynamic price entries displaying prices corresponding to the bids and the offers;
providing an order entry region at least partially coextensive with the dynamic bid and dynamic offer entries, the order entry region comprising a plurality of areas for receiving commands from the user input device to send trade orders; and
selecting a particular area in the order entry region through an initial single user action of the user input device with a pointer of the user input device positioned over the particular area to display a particular order region showing order parameters for the trade order.

27. The method of claim 26, further comprising the step of again selecting the particular order region through a final single user action of the user input device to send the trade order to the electronic exchange.

28. The method of claim 26, wherein following the initial selection of the particular area in the order entry region through the initial single user action, a different area in the order entry region is selected through subsequent initial single user action, thereby displaying the same or different order parameters depending upon movement in the market for the traded instrument.

29. A graphical user interface communicating with a computer and a user input device for use in electronically trading an instrument on an electronic exchange having an inside market, comprising:
a visual display of market depth of the traded instrument using bid and offer ladders comprising a plurality of bids and a plurality of offers in the market for the traded instrument, the bid and offer ladders including at least a portion of the bid and offer quantities of the traded instrument and being aligned with a price ladder displaying prices corresponding to the bids and the offers;
wherein a portion of one or more of the bid, offer and price ladders located in areas substantially remote the center of the visual display is compressed relative to other portions of the ladders adjacent the center of the visual display.

30. The graphical user interface of claim 29, wherein a portion of one or more of the bid, offer and price ladders located in areas substantially remote from the center of the visual display is compressed relative to the portion of the ladders adjacent the center of the visual display.

31. The graphical user interface of claim 29, wherein the bid and offer ladders are dynamic, and are aligned with a dynamic price ladder.

32. The graphical user interface of claim 29, wherein the bid and offer ladders are aligned with a static price ladder.

33. The graphical user interface of claim 29, further comprising:
an order entry region at least partially coextensive with the bid and offer ladders, the order entry region comprising a plurality of areas for receiving commands from the user input device to send trade orders;
wherein a particular area in the order entry region may be selected through an initial single user action of the user input device with a pointer of the user input device positioned over the particular area to display a particular order region showing order parameters for the trade order, and whereby the particular order region may again be selected through a final single user action of the user input device to send the trade order to the electronic exchange.

34. A graphical user interface communicating with a computer and a user input device for use in electronically trading an instrument on an electronic exchange having an inside market, comprising:
a visual display of market depth of the traded instrument showing aligned bid, offer and dynamic price ladders;
wherein one or more bid, offer or price entries within the ladders are automatically differentiated for the user in a visually perceptible manner from other such entries, facilitating the user's ability to track market movement for the traded instrument.

35. The graphical user interface of claim 34, wherein differentiation is provided by color-coded highlighting or bordering of one or more bid, offer or price entries, wherein the color-coding enables the user to more easily differentiate between bid, offer and price entries.

36. A graphical user interface communicating with a computer and a user input device, for use in electronically trading an instrument on an electronic exchange having an inside market, comprising:
a visual display of market depth of the traded instrument using bid and offer ladders comprising a plurality of bids and a plurality of offers in the market for the traded instrument, the bid and offer ladders including at least a portion of the bid and offer quantities of the traded instrument and being aligned with a price ladder displaying prices corresponding to the bids and the offers;
wherein when a range of available bid or offer volumes reaches an edge of the visual display, the price ladder converts from a static to a dynamic display.

37. The graphical user interface of claim 36, wherein a portion of one or more of the bid, offer and price ladders located in areas substantially remote the center of the visual display is compressed relative to other portions of the ladders adjacent the center of the visual display.
